(19) United States
(12) Patent Application Publication
(10) Pub. No.: US 2016/0125732 A1
(43) Pub. Date: May 5, 2016

(54) METHOD OF CONTROLLING A REMOTE CONTROLLED SYSTEM

(71) Applicant: GRAND MATE CO., LTD., Taichung (TW)

(72) Inventors: CHUNG-CHIN HUANG, TAICHUNG (TW); CHIN-YING HUANG, TAICHUNG (TW); HSIN-MING HUANG, TAICHUNG (TW); HSING-HSIUNG HUANG, TAICHUNG (TW); YEN-JEN YEH, TAICHUNG (TW); KUAN-CHOU LIN, TAICHUNG (TW); YU-CHIN TSAI, TAICHUNG (TW)

(73) Assignee: GRAND MATE CO., LTD., TAICHUNG (TW)

(21) Appl. No.: 14/527,362

(22) Filed: Oct. 29, 2014

(51) Int. Cl. G08C 19/16

(52) U.S. Cl. CPC G08C 19/16

(57) ABSTRACT

A method of controlling a remote controlled system includes the steps of: A. establishing corresponding relationships between a detector and home appliances; B. measuring a specific physical quantity with the detector; C. determining if the measured physical quantity is abnormal; and D. controlling the corresponding home appliances to perform certain operations according to the corresponding relationships if the measured physical quantity is abnormal, whereby, the physical quantity measured by a common detector can be feedbacked to multiple home appliances, which effectively reduces the number of the required detectors.

### BACKGROUND OF THE INVENTION

1. Technical Field

The present invention relates generally to controlling home appliances, and more particularly to a method of controlling a remote controlled system.

2. Description of Related Art

It is convenient to control home appliances with remote controls, since a user no longer has to go to where a home appliance is to control it. However, with the increase in the number of remote controls in any modern home, identifying a particular remote control for a home appliance among others when needed has become increasingly challenging, particularly since some remote controls even look alike. A user may thus find it inconvenient to distinguish the paring relationships between each different home appliance and its corresponding remote control.

Hence, one kind of relay apparatus which can be communicated through a wireless network is introduced to solve the problem. By using electronic devices such as tablet computers or smart phones, a user is able to transmit control commands to a relay apparatus, and the relay apparatus then converts the received control commands into corresponding control signals to be sent to specific home appliances. In this way, one electronic device is capable of controlling multiple home appliances, and thereby eases the trouble of dealing with too many remote controls.

A problem persists with such remote control systems insofar as the home appliances communicated with the same relay apparatus are not synchronized with each other. For example, a detector wirelessly connected to a relay apparatus measuring certain physical quantity is not synchronized to relay abnormal readings of its detector to an electronic device for display, and thus there is no feedback relayed to other home appliances for proceeding any corresponding operations. An ongoing disadvantage of remotely controlled home appliances is there lack of feedback between detectors in response to abnormal readings such that operations are synchronized to correspond and proceed according to the abnormal conditions detected and may, therefore, incur unnecessary cost.

### SUMMARY OF THE INVENTION

In view of the above, a primary objective of the present invention is to provide a method of controlling a remote controlled system, comprising feedback readings of detectors to other home appliances.

The present invention provides a method of controlling a remote controlled system, wherein the remote controlled system includes at least a detector and a feedback between a plurality of home appliances. The method includes the steps of: A. Establishing corresponding relationships between the detector and at least one of the home appliances; B. Measuring a specific physical quantity with the detector; C. Determining if the physical quantity measured by the detector is abnormal; and D. Controlling at least one of the home appliances to perform operations based on the corresponding relationships if the physical quantity is abnormal.

With the method provided in the present invention, when the physical quantity measured by the detectors is found abnormal, the information can be feedbacked to the corresponding home appliances. The method requires fewer detectors than the conventional way of controlling home appliances.

### BRIEF DESCRIPTION OF THE SEVERAL VIEWS OF THE DRAWINGS

The present invention will be best understood by referring to the following detailed description of some illustrative embodiments in conjunction with the accompanying drawing, in which

FIG. 1 is a schematic diagram showing the remote controlled system of a first preferred embodiment of the present invention.

### DETAILED DESCRIPTION OF THE INVENTION

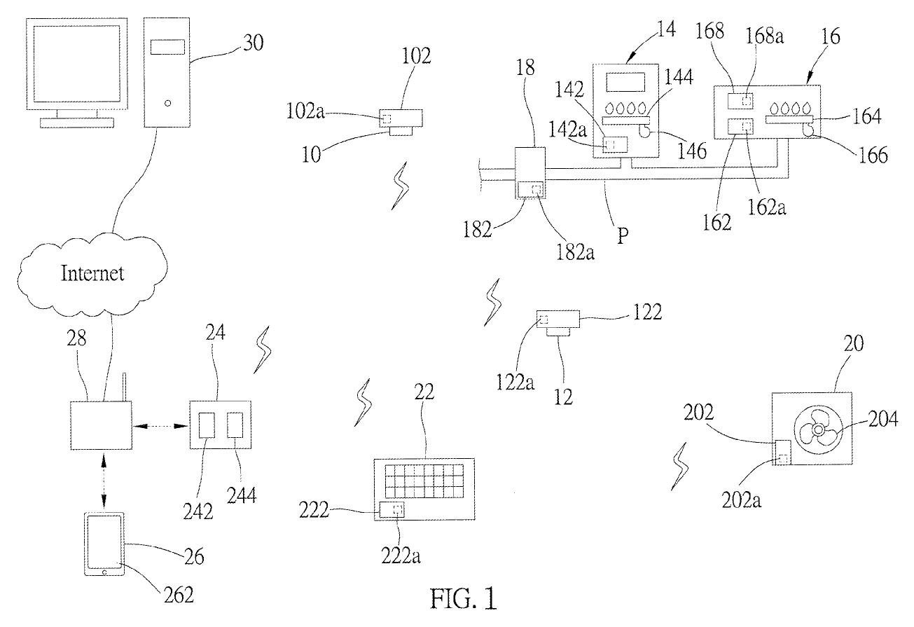

As shown in a preferred embodiment of the present invention illustrated in FIG. 1, a remote controlled system for coordinating detection of abnormal concentrations by multiple home appliances includes a plurality of detectors (a carbon monoxide detector 10 and a smoke detector 12 in the preferred embodiment), a plurality of home appliances (a water heater 14, a fireplace 16, a gas regulator 18, a ventilation device 20, and an air conditioner 22 in the preferred embodiment), a relay apparatus 24, an electronic device which is a tablet computer 26 as an example, and a server 30 at a far end. The detectors, home appliances, and the relay apparatus 24 are installed at a near end thereof.

Each detector is respectively used to detect a specific physical quantity specifically including a physical quantity detected by the carbon monoxide detector 10 is the concentration of carbon monoxide, while the physical quantity detected by the smoke detector 12 is the concentration of smoke particles.

The carbon monoxide detector 10 and the smoke detector 12 are respectively electrically connected to a control device 102, 122. Each of the control devices 102, 122 has a wireless signal transmission circuit 102a, 122a, which communicates to the relay apparatus 24 with signals. Each of the control device 102, 122 respectively stores an ID code corresponding to the belonging detector 10, 12.

In addition, the control device 102 connected to the carbon monoxide detector 10 stores a critical value and an abnormal value which is lower than the critical value, wherein the concentration of carbon monoxide higher than the critical value is high enough to cause immediate harm, and if the concentration of carbon monoxide exceeds the abnormal value yet not reaches the critical value, it is not really harmful but still not good for anyone to stay in such circumstance for too long. Once the control device 102 finds out that the concentration of carbon monoxide measured by the detector 10 exceeds the critical value, it sends out an critical signal to the relay apparatus 24 through the wireless signal transmission circuit 102a; if the control device 102 determines that the concentration of carbon monoxide measured by the carbon monoxide detector 10 is between the abnormal value and the critical value, it sends out a warning signal to the relay apparatus 24. Furthermore, if the control device 102 finds out that the concentration of carbon monoxide stays between the abnormal value and the critical value for a certain period of time, it also sends out the critical signal for safety reasons.

Similarly, the control device 122 connected to the smoke detector 12 also stores a critical value and an abnormal value for the concentration of smoke particles, wherein the concentration of smoke particles higher than the critical value means a fire hazard is taking place. If the control device 122 finds out that the concentration of smoke particles detected by the detector 12 exceeds the critical value, it sends out a critical signal to the relay apparatus 24 through the wireless signal transmission circuit 122a.

In the preferred embodiment, the home appliances 14, 16, 18, 20, 22 can be classified into two types, which are gas appliances and electric equipment. More specifically, the water heater 14, the fireplace 16, and the gas regulator 18 belong to the type of gas appliances, while the ventilation device 20 and the air conditioner 22 belong to the type of electric equipment. Each of the home appliances 14, 16, 18, 20, 22 includes a control device 142, 162, 182, 202, 222 to control the operations thereof; each of the control devices 142, 162, 182, 202, 222 has a wireless signal receiving circuit 142a, 162a, 182a, 202a, 222a to receive control commands, and the control device 142, 162, 182, 202, 222 of each of the home appliances 14, 16, 18, 20, 22 controls the home appliances 14, 16, 18, 20, 22 to perform operations correspondingly. The home appliances 14, 16, 18, 20, 22 perform a specific operation after receiving an abnormal operation command, which will be described in details later. Each of the control devices 142, 162, 182, 202, 222 stores an ID code corresponding to the belonging home appliance 14, 16, 18, 20, 22.

In a preferred embodiment, the water heater 14 and the fireplace 16 are installed indoors, and they are communicated to a same gas pipe P. The water heater 14 includes burner 144 and blower 146 connected to burner 144, wherein the burner 144 burns gas and the blower 146 can be controlled by the control device 142 to change its rotational speed to regulate the air amount flowing into burner 144 for combustion. Water heater 14 further includes an exhaust pipe (not shown) to vent the exhaust gas generated due to burning gas.

In addition to burner 164, blower 166, and an exhaust pipe (not shown), the fireplace 16 further includes an oxygen depletion sensor (ODS) 168, which has an oxygen concentration detector 168a, and the physical quantity measured by the oxygen concentration detector 168a is the oxygen concentration while the fireplace 16 is burning gas. The control device 162 of fireplace 16 also stores a critical value and an abnormal value which is higher than the critical value. Similarly, if control device 162 finds out that the oxygen concentration measured by the oxygen concentration detector 168a is lower than the critical value, it sends out a critical signal to the relay apparatus 24 through the wireless signal transmission circuit 162a; if control device 162 determines that the oxygen concentration is between the critical value and the abnormal value, it sends out an abnormal signal. Since the oxygen concentration detector 168a is one kind of detectors, control device 162 also stores an ID code corresponding to the oxygen concentration detector 168a.

The gas regulator 18 is installed at a source of the gas pipe P, wherein control device 182 controls a valve (not shown) of the gas regulator 18 to open or close the gas pipe P.

The ventilation device 20 is installed at a vent of a building, wherein ventilation device 20 includes an exhaust fan 204, and control device 202 thereof controls the exhaust fan 204 to operate to provide indoor and outdoor air exchange. The control device 222 controls the operation of air conditioner 22 to adjust room temperature.

The relay apparatus 24 has a memory 242 and a wireless transceiver circuit 244, wherein memory 242 stores interaction information, which designates corresponding interactions between each of the detectors and at least one of the home appliances. The wireless transceiver circuit 244 communicates with control devices 102, 122, 142, 162, 182, 202, 222.

Tablet computer 26 communicates with the relay apparatus 24 with WiFi signals through an access point (AP) 28, wherein tablet computer 26 can be used to control the home appliances through the relay apparatus 24. Tablet computer 26 has an alarm unit such as screen 262, which is shown as an example.

Server 30 communicates with the AP 28 through Internet to communicate with the relay apparatus 24. The server 30 is provided by a manufacturer of the remote controlled system, wherein the server has a database, which stores the ID codes corresponding to a plurality of detectors available from the manufacturer and a plurality of home appliances. In other words, the database stores information about the corresponding relationship between the ID codes and the detectors or the home appliances.

The method provided in the present invention includes the following steps:

First, the relay apparatus 24 transmits the ID codes corresponding to the detectors and the home appliances at the near end to server 30, and server 30 determines what interactions are possible between the detectors at the near end and the home appliances available from the manufacturer based on the information stored in the database. The ID codes of the home appliances and the detectors at the near end which are able to take interactions are recorded in this way, and therefore the corresponding relationships between the detectors and the home appliances at the near end are established and noted. Such information is then transmitted back to relay apparatus 24 and to be stored in memory 242. The herein stored information is the aforementioned interaction information.

For example, the interaction information stored in the memory 242 of the relay apparatus 24 includes the corresponding relationships between the carbon monoxide detector 10 and water heater 14, fireplace 16, and ventilation device 20. Furthermore, corresponding relationship between the oxygen concentration detector 162a of fireplace 16 and ventilation device 20, the corresponding relationships between smoke detector 12 and the water heater 14, fireplace 16, gas regulator 18, and air conditioner 22 are also included in the interaction information.

If control device 102 connected to carbon monoxide detector 10 finds out that the concentration of carbon monoxide measured by the carbon monoxide detector 10 reaches the abnormal value, it sends out the warning signal to the relay apparatus 24. The warning signal carbon monoxide detector 10 relays to apparatus 24 triggers transmit of a corresponding warning signal to tablet computer 26. This enables screen 262 can display a warning message to inform the user that the concentration of carbon monoxide is abnormally high. If the concentration of carbon monoxide stays between the abnormal value and the critical value for a certain period of time, or if the concentration of carbon monoxide reaches the critical value, control device 102 sends out the critical signal. After receiving the critical signal, according to the interaction information stored in memory 242, the relay apparatus 24 transmits the abnormal operation command to the corresponding home appliances, namely, the water heater 14, the fireplace 16, and the ventilation device 20. Consequently, blowers 144, 146 of water heater 14 and fireplace 16 are controlled to increase their rotational speed. Exhaust fan 204 is also switched on to exhaust the carbon monoxide out more effectively for safety reasons. At the same time, relay apparatus 24 also transmits the critical signal to tablet computer 26 for displaying, and the user can be informed that the concentration of carbon monoxide is high enough to be harmful.

Similarly, if control device 162 of the fireplace 16 finds out that the oxygen concentration measured by the oxygen concentration detector 168a is lower than the abnormal value, it sends out the warning signal to be displayed on tablet computer 26 through relay apparatus 24. If the oxygen concentration is between the abnormal value and the critical value, or if it reaches the critical value, the critical signal is sent out, and relay apparatus 24 transmits the abnormal operation command to ventilation device 20 based on the interaction information, which switches on exhaust fan 204 to create indoor and outdoor air exchange to increase the indoor oxygen concentration. Again, relay apparatus 24 also transmits the critical signal to tablet computer 26 for displaying, and the user can be informed that the oxygen concentration is abnormal.

If control device 122 connected to smoke detector 12 finds out that the concentration of smoke particles is higher than the critical value, it means there is a fire hazard taking place, and the critical signal is sent to the relay apparatus 24. After that, the relay apparatus 24 transmits the abnormal operation command to water heater 14, the fireplace 16, gas regulator 18, and air conditioner 22 according to the interaction information, which makes water heater 14, fireplace 16, gas regulator 18, and air conditioner 22 stop operating, and gas regulator 18 is also controlled to close gas pipe P.

In summary, the method of controlling a remote controlled system provided in the present invention takes the physical quantities measured by common detectors as a basis of controlling home appliances. In light of this, the method requires fewer detectors than conventional remote control systems.

It must be pointed out that the embodiment described above is only a preferred embodiment of the present invention. All equivalent methods which employ the concepts disclosed in this specification and the appended claims are contemplated to fall within the scope of the present invention.

What is claimed is:

1. A method of controlling a remote controlled system, wherein the remote controlled system includes at least a detector and a plurality of home appliances; comprising the steps of:
establishing corresponding relationships between the detector and at least one of the home appliances;
measuring a specific physical quantity with the detector;
determining if the physical quantity measured by the detector is abnormal; and
controlling at least one of the home appliances to perform operations based on the corresponding relationships if the physical quantity is abnormal.

2. The method of claim 1, wherein one of the home appliances includes the detector; the detector measures the specific physical quantity while the home appliance is operating.

3. The method of claim 2, wherein one of the home appliances is a gas appliance, and the detector is an oxygen concentration detector which measures oxygen concentration while the gas appliance is burning gas; one of the at least one of the home appliances includes an exhaust fan; the physical quantity is the oxygen concentration while the gas appliance is burning gas; and wherein the step of controlling at least one of the home appliances to perform operations based on the corresponding relationships if the physical quantity is abnormal comprises switching on the exhaust fan.

4. The method of claim 1, wherein the remote controlled system includes a relay apparatus, which communicates with the detector and the home appliances with signals; the corresponding relationships are established in the relay apparatus; if the physical quantity measured by the detector is abnormal, a critical signal is generated to be received by the relay apparatus; and wherein the relay apparatus transmits an abnormal operation command to the corresponding home appliances for performing corresponding operations after receiving the critical signal.

5. The method of claim 4, wherein the relay apparatus, the at least one detector and the home appliances are at a near end; the remote controlled system further includes a server which communicates with the relay apparatus through internet; the server has a database, which stores corresponding relationships between a plurality of different detectors and a plurality of different home appliances; and wherein the step of establishing corresponding relationships between the detector and at least one of the home appliances is provided by retrieval from the database of the server and then established in the relay apparatus.

6. The method of claim 5, wherein the corresponding relationships stored in the database is represented by ID codes corresponding to the different detectors and the different home appliances; the corresponding relationships mentioned in step A is retrieved by transmitting the ID codes corresponding to the at least one detector and the home appliances at the near end to the server to be compared with the ID codes in the data base.

7. The method of claim 4, further comprising the step of predetermining a critical value and an abnormal value, wherein before reaching the critical value, the physical quantity reaches the abnormal value first; if the measured physical quantity reaches the abnormal value, a warning signal is generated to be received by the relay apparatus, which then transmits the warning signal to an alarm unit for alarming; if the measured physical quantity reaches the critical value, the critical signal is generated.

8. The method of claim 1, further comprising the step of predetermining a critical value and an abnormal value, wherein before reaching the critical value, the physical quantity reaches the abnormal value first; a critical signal is generated if the measured physical quantity reaches the critical value, or if the measured physical quantity stays between the abnormal value and the critical value for a certain period of time.

9. The method of claim 1, wherein the detector is a carbon monoxide detector; one of the at least one of the home appliances includes an exhaust fan; the physical quantity is concentration of carbon monoxide; and wherein the step of controlling at least one of the home appliances to perform operations based on the corresponding relationships if the physical quantity is abnormal comprises switching on the exhaust fan.

10. The method of claim 1, wherein the detector is a carbon monoxide detector; one of the at least one of the home appliances is a gas appliance, which includes a burner and a blower; the physical quantity is concentration of carbon monoxide; and wherein the step of controlling at least one of the home appliances to perform operations based on the corresponding relationships if the physical quantity is abnormal comprises speeding up a rotational speed of the blower.

11. The method of claim 10, further comprising the step of predetermining a critical value and an abnormal value, wherein before reaching the critical value, the physical quantity reaches the abnormal value first; a critical signal is generated if the measured physical quantity reaches the critical value, or if the measured physical quantity stays between the abnormal value and the critical value for a certain period of time.

12. The method of claim 1, wherein the detector is a smoke detector; the at least one of the home appliances includes a gas appliance and a gas regulator; the gas appliance communicates with a gas pipe, and the gas regulator is installed on the gas pipe; the physical quantity is concentration of smoke particles; and wherein the step of controlling at least one of the home appliances to perform operations based on the corresponding relationships if the physical quantity is abnormal comprises switching off operation of the gas appliance and controlling the gas regulator is to close the gas pipe.
